(19) United States
(12) Patent Application Publication
(10) Pub. No.: US 2007/0169359 A1
(43) Pub. Date: Jul. 26, 2007

(54) Optical horizontal measurement device

(76) Inventor: Chin-Hui Lin, Taipei (TW)

Correspondence Address: CHIN-HUI LIN, 235 Chung-Ho, Box 8-24, Taipei, TW

(21) Appl. No.: 11/335,778

(22) Filed: Jan. 20, 2006

(51) Int. Cl. G01C 15/00

(52) U.S. Cl. 33/286

(57) ABSTRACT

An optical horizontal measurement device utilizes a knob containing a light-beam module for projecting a beam of light in a particular direction so as to perform an angular measurement, whereby we can draw a line in accordance with the beam. The optical horizontal measurement device is kept in a horizontal configuration based on a horizontal bubble tube. The optical horizontal measurement device further includes a supplementary metallic plate for being mounted firstly at a measurement location. The optical horizontal measurement device then can be locked with the supplementary metallic plate.

### FIELD OF THE INVENTION

The present invention relates horizontal measurement devices, more particularly to an optical horizontal measurement device having a knob containing a light-beam module capable of sending a laser beam over a long distance, whereby the measurement of an angle between a reference direction and the direction the laser beam points can be done quickly.

### BACKGROUND OF THE INVENTION

Some types of the horizontal measurement devices of the prior art comprise many optical components and motors and therefore have the problems of high production cost and poor portability. Further, the conventional optical horizontal measurement devices are for measuring horizontal or vertical lines. It is necessary that practical measurements for engineering uses require angle measurements for lines, which can be done by the conventional devices only through time-consuming iterative measurement.

Further, to use a horizontal measurement device on a vertical wall, the measurement location for the device should be fixed firstly, and then the other paths can be drawn, which is not easy at all. Therefore, how to draw a line of particular angle determined by a horizontal measurement device on a wall is difficult.

As one other disadvantage, when a conventional optical horizontal measurement device is used to draw a horizontal line at a point. The observer cannot see through the device and has to firstly draw the contour of the optical horizontal measurement device on a paper, so that the line can be drawn.

### BRIEF DESCRIPTION OF THE DRAWINGS

FIG. 1 is a perspective view of an optical horizontal measurement device of the present invention.

FIG. 2 is another perspective view of the optical horizontal measurement device wherein the knob is separated from the shell body.

FIG. 3 is a perspective view of another preferred embodiment of the present invention wherein a supplementary metallic plate is attached on an optical horizontal measurement device.

FIG. 4 is a perspective view of one side of a supplementary metallic plate.

FIG. 5 is a perspective view of the opposite side of the supplementary metallic plate in FIG. 4.

FIG. 6 is a perspective view of the shell body of the present invention receiving a plurality of magnets.

FIG. 7 is a bottom view of the supplementary metallic plate.

FIG. 8 is a top view of the optical horizontal measurement device being calibrated.

FIG. 9 is a top view of the optical horizontal measurement device measuring an angle.

FIG. 10 is another top view of the optical horizontal measurement device measuring an angle.

FIG. 11 is a bottom view of the optical horizontal measurement device in FIG. 1.

### SUMMARY OF THE INVENTION

Accordingly, the primary objective of the present invention is to provide an optical horizontal measurement device utilizes the character of light that it goes along a straight in a medium to have an optical module within the device, which is coupled with a knob so as to adjust the projection angle of a light beam freely and easily. Thereby, the light beam can be used to make engineering drawings.

The secondary objective of the present invention is to provide an optical horizontal measurement device that overcomes the problem of retaining the measurement device on a vertical wall. The optical horizontal measurement device utilizes a supplementary metallic plate attached on a wall and a plurality of magnets installed in the device. The device is going through a process of fine adjustment so that it attains a horizontal state and then used to draw lines of various angles.

It is a further objective of the present invention that the alignment and retention of the supplementary metallic plate on a wall is solved. The supplementary metallic plate is provided with an alignment hole that is aligned with a reference point on the wall when the plate is attached thereon. The horizontal position of the reference point is measured first. The optical horizontal measurement device is then mounted on the supplementary metallic plate, whereby a horizontal line needed can be quickly drawn. The supplementary metallic plate is further provided with a retaining hole to be pierced through with a nail for being mounted on a wall or to be attached on a wall by a double-sided adhesive pad. Correspondingly, the bottom of the lower shell is provided with a retaining portion with a capacity roughly the same as the size of the supplementary metallic plate for receiving the supplementary metallic plate. Therefore, the supplementary metallic plate can be stored in the optical horizontal measurement device, which enhances the portability.

To achieve above object, the present invention provides an optical horizontal measurement device which comprises a shell body further comprising an upper shell and a lower shell; a horizontal indicator attached on the shell body for a person to observe the horizontal inclination of the optical horizontal measurement device; a light-beam turntable further comprising a knob and a light-beam module both mounted on the upper shell, the knob being provided with a hole for emitting a light beam from the light-beam module installed therein; and a power supply further comprising a battery and a switch for activating the light-beam module. The horizontal indicator is a bubble tube. The battery is installed in a place selected from the shell body and the knob; the switch being mounted on a place selected from the shell body and the knob. Furthermore the lower shell further including a retaining unit for assisting confining the knob; the retaining unit comprising at least a retaining projection for engaging a retaining slot on the lower shell, whereby a lateral wall of the knob will be retarded as the knob rotates. The optical horizontal measurement device further includes a supplementary metallic plate for assisting attaching the optical horizontal measurement device on a bottom of the shell body by the attraction between the supplementary metallic plate and a plurality of magnets installed on the bottom of the shell body.

The various objects and advantages of the present invention will be more readily understood from the following detailed description when read in conjunction with the appended drawings.

### DETAILED DESCRIPTION OF THE PREFERRED EMBODIMENTS

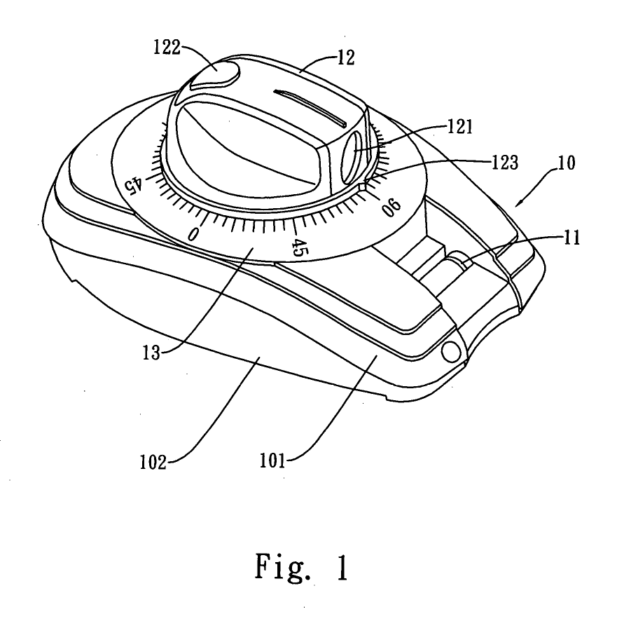

Referring to FIG. 1, an optical horizontal measurement device according to the present invention comprises a shell body 10, a bubble tube 11 and a knob 12; the knob 12 further contains a laser emitter (not shown in the figure). The shell body 10 further comprises an upper shell 101 and a lower shell 102. The bubble tube 11 is attached onto the inner wall of the shell body 10 and is exposed to the exterior through a window opened on the upper shell 101, whereby a person can observe the horizontal state of the optical horizontal measurement device. Further, the knob 12 is mounted on the upper shell 101 and has a front hole 121 for emitting a laser beam. A cursor 123 is formed underneath the hole 121, whereby the cursor 123 pointing against an indicator 13 surrounding the knob 12 will be used to determined an angle, as the laser beam is being fired. More specifically, what the cursor 123 indicates is the angle between the laser beam and the bubble tube 11. Further, there is a push button 122 that controls the on/off of the laser emitter.

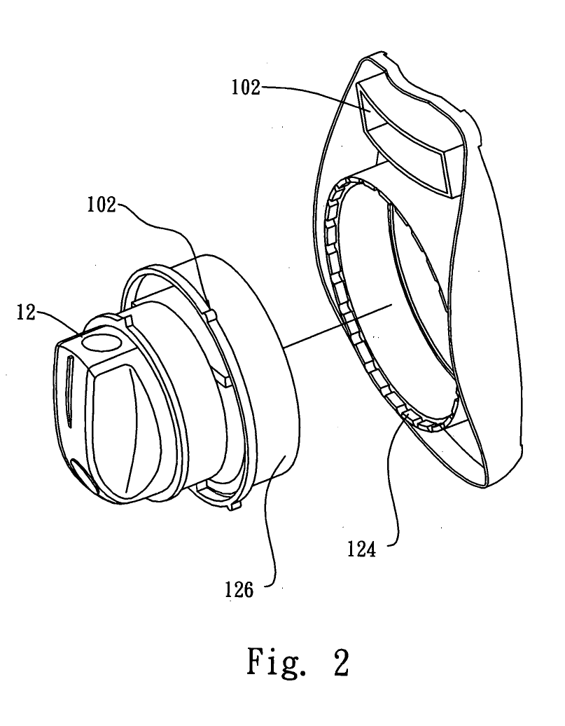

As shown in FIG. 2, to retain the knob 12 stably at angle on the indicator 13, there are a multitude of retaining slots 124 surrounding a hole in the lower shell 102 and a multitude of corresponding retaining projections 125 on the lateral wall of the knob 12, whereby as the knob 12 is being rotated, the retaining projections 125 will slide against the retaining slots 124, and whereby as the knob 12 stops rotating, the retaining projections 125 will be retained by the retaining slots 124, and therefore the angle adjusted will be stably maintained. There is a battery room 126 under the knob 12 for supplying the electricity for the laser emitter.

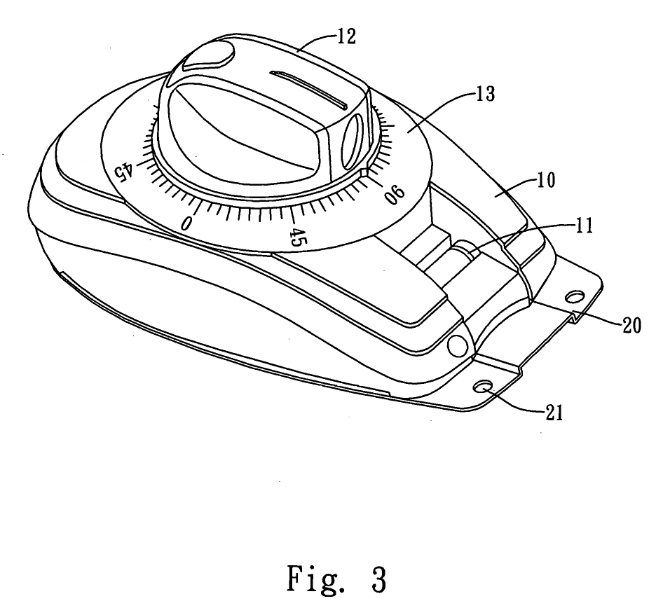

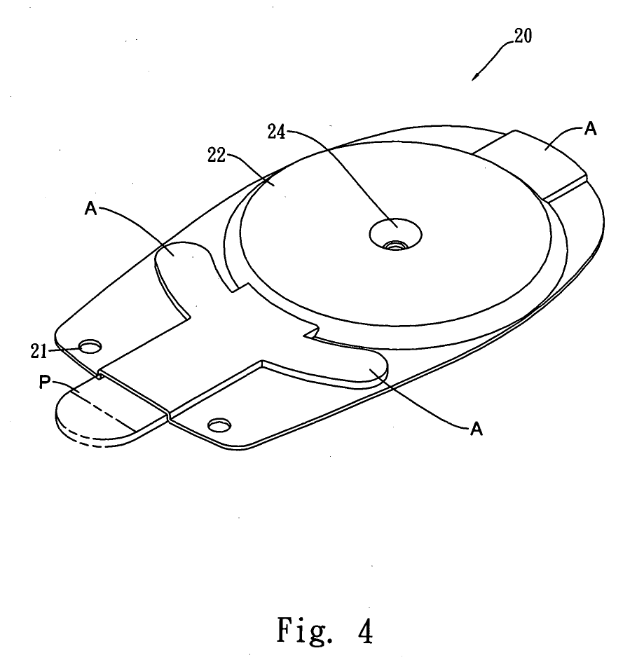

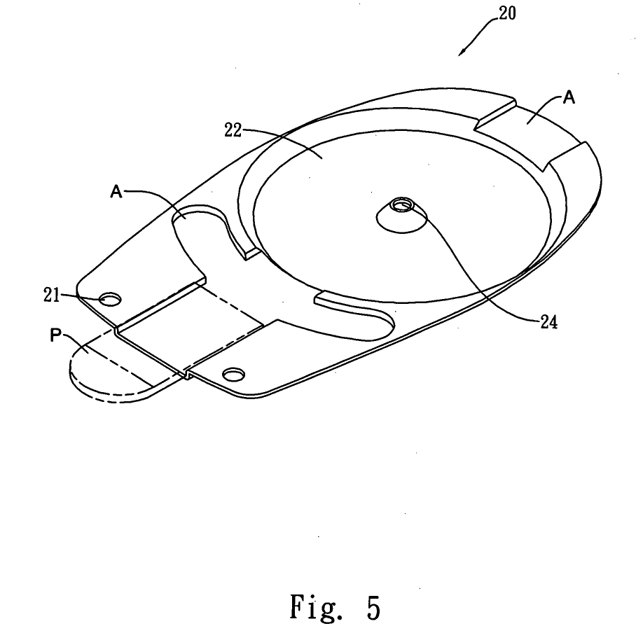

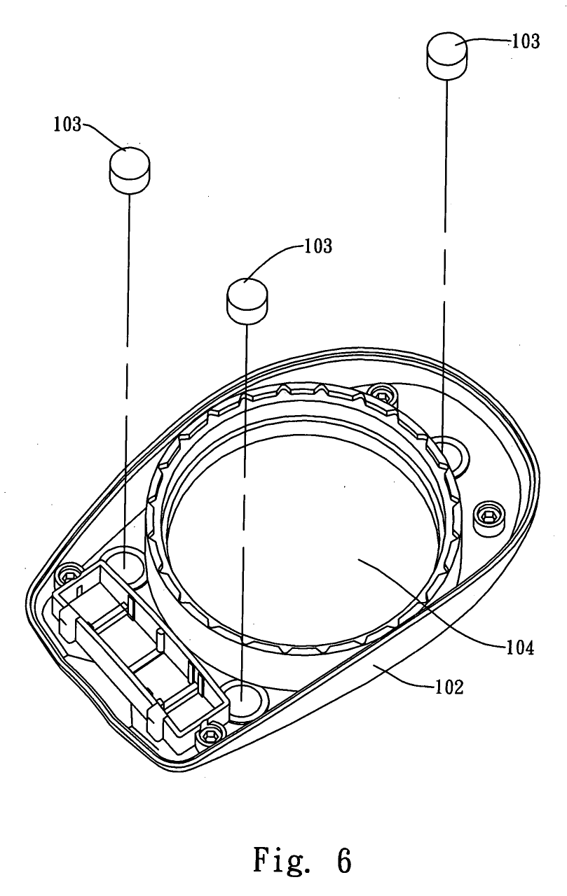

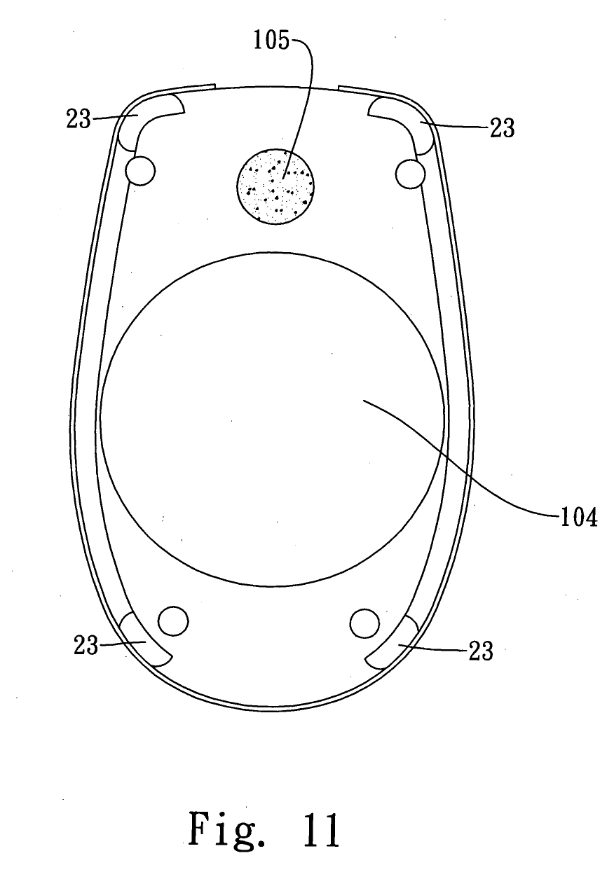

For better pre-measurement alignment, the optical horizontal measurement device is provided with a supplementary metallic plate 20, as shown in FIGS. 4 to 6. The supplementary metallic plate 20 comprises an alignment hole 24, a retaining hole 21, a locking portion 22 and an attachment area A. The alignment hole 24 is used to lock in a reference point on a wall, and the retaining hole 21 is to be pieced through by a nail for mounting the supplementary metallic plate 20 on the wall at the reference point, which can also be done by using a double-sided adhesive pad P. Further, three magnets 103 are installed within the lower shell 102 for being attracted by the attachment area A on the supplementary metallic plate 20. The lower shell 102 is further provided with a opening 104 that can be locked with the locking portion 22 of the supplementary metallic plate 20, as shown in FIG. 3. The supplementary metallic plate 20 is firstly aligned with a reference point and then mounted on the wall of the reference point so as to start the measurement. If the measurement device is not in a horizontal state, it can be adjusted by being rotated about the locking portion 22 on the supplementary metallic plate 20. Referring to FIG. 11, a slide-resisting pad 105 is attached on the bottom of the lower shell 102 to increase the friction between the optical horizontal measurement device and the supplementary metallic plate 20, facilitating the adjustment. The slide-resisting pad 105 is made of a slide-resisting material, such as rubber.

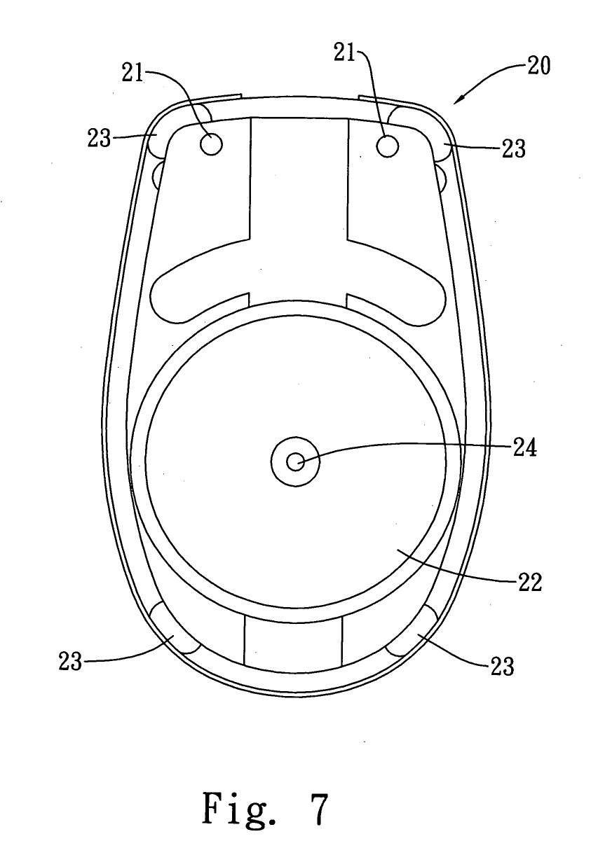

Referring to FIG. 7, the lower shell 102 is further provided with a retaining portion 23 having a receiving capacity roughly the same as the size of the supplementary metallic plate 20, thereby housing the supplementary metallic plate 20 when it is not used.

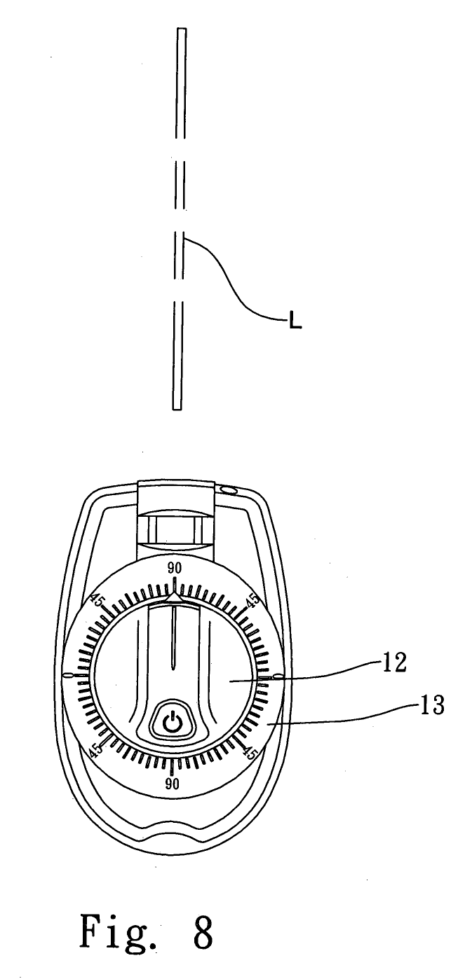

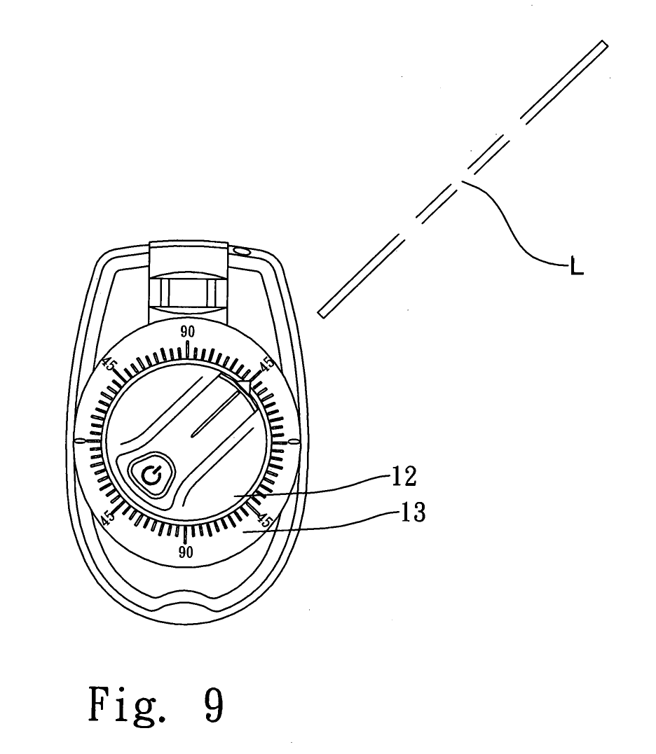

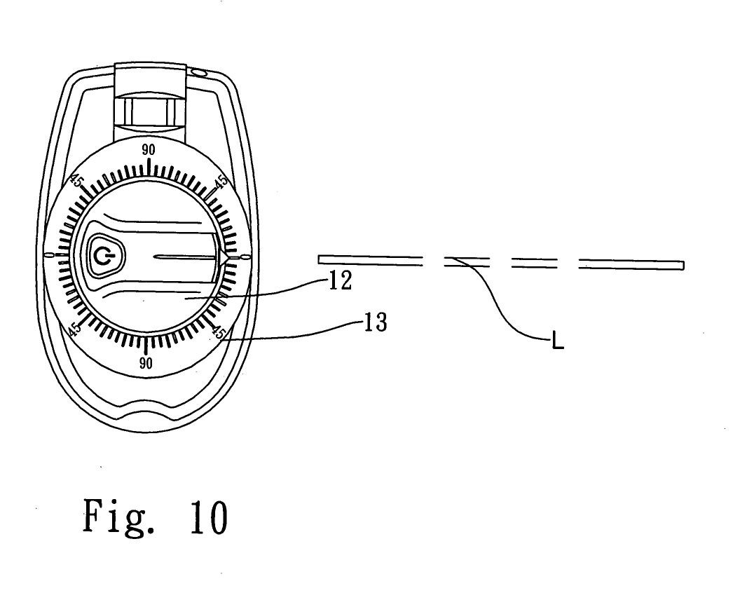

Referring to FIGS. 8 to 10, the optical horizontal measurement device is firstly mounted within an operation area and then adjusted for attaining a horizontal state. The laser emitter is then turned on to eject a beam L that a person in the operation area can easily see. The beam L is them be directed to a required direction by adjusting the knob against the surrounding indicator 13 for the angle between the beam L and a reference direction. Thereby, the line of a particular angle can be easily drawn.

The present invention is thus described, and it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. An optical horizontal measurement device, comprising:
a shell body further comprising an upper shell and a lower shell;
a horizontal indicator attached on said shell body for a person to observe the horizontal inclination of said optical horizontal measurement device;
a light-beam turntable further comprising a knob and a light-beam module both mounted on said upper shell, said knob being provided with a hole for emitting a light beam from said light-beam module installed therein; and
a power supply further comprising a battery and a switch for activating said light-beam module.

2. The optical horizontal measurement device of claim 1 wherein said horizontal indicator is a bubble tube.

3. The optical horizontal measurement device of claim 1 wherein said battery is installed in a place selected from said shell body and said knob; said switch being mounted on a place selected from said shell body and said knob.

4. The optical horizontal measurement device wherein said lower shell further including a retaining unit for assisting confining said knob; said retaining unit comprising at least a retaining projection for engaging a retaining slot on said lower shell, whereby a lateral wall of said knob will be retarded as said knob rotates.

5. The optical horizontal measurement device of claim 1 further including a supplementary metallic plate for assisting attaching said optical horizontal measurement device on a bottom of said shell body by the attraction between said supplementary metallic plate and a plurality of magnets installed on said bottom of said shell body.

6. The optical horizontal measurement device of claim 5 wherein said supplementary metallic plate further comprises a locking portion an attachment area; said lower shell further including a groove for the insertion of said locking portion; said attachment area being where said magnets are attracted.

7. The optical horizontal measurement device of claim 5 wherein said supplementary metallic plate further comprises at least an alignment hole aligned to a pivoting center of said knob when said supplementary metallic plate is integrated with said optical horizontal measurement device and at least a retaining hole.

8. The optical horizontal measurement device of claim 5 wherein said bottom of said shell body is further provided with a retaining portion for housing said supplementary metallic plate and a slide-resisting pad that enhances the friction between said shell body and said slide-resisting pad.

9. The optical horizontal measurement device of claim 1 further including a supplementary metallic plate comprising a locking portion an attachment area; said lower shell further including a groove for the insertion of said locking portion; said attachment area being where said magnets are attracted.

10. The optical horizontal measurement device of claim 9 wherein said supplementary metallic plate further comprises at least an alignment hole aligned to a pivoting center of said knob.
